(19) United States
(12) Patent Application Publication
(10) Pub. No.: US 2012/0179519 A1
(43) Pub. Date: Jul. 12, 2012

(54) MAILABLE ITEM WITH PRODUCT INFORMATION

(75) Inventors: Simon S. Vance, Grand Rapids, MI (US); Harold E. Morse, Grand Rapids, MI (US); Karlis Vecziedins, Caledonia, MI (US); Terry L. Lautzenheiser, Nunica, MI (US); Michael E. Miles, Grand Rapids, MI (US); Richard B. Bylsma, Ada, MI (US)

(73) Assignee: ACCESS BUSINESS GROUP INTERNATIONAL LLC, Ada, MI (US)

(21) Appl. No.: 13/344,822

(22) Filed: Jan. 6, 2012

Related U.S. Application Data
(60) Provisional application No. 61/430,729, filed on Jan. 7, 2011.

(51) Int. Cl. G06Q 10/00; G06Q 30/02

(52) U.S. Cl. 705/14.4; 705/1.1

(57) ABSTRACT

A method for product information retrieval with a mailable item. The method includes providing a mailable item with a communication system and memory, transferring product usage information from the product to the mailable item, and mailing the mailable item to a recipient who can retrieve and analyze the product information. Incentives can be offered to entice a user to obtain the mailable item and/or to return the mailable item.

### BACKGROUND OF THE INVENTION

The present invention relates to a system and method for retrieving product information.

Many products include memory that stores information about the product, such as serial number, manufacturing date, time of installation, or number of actuations. Retrieval of this information can be useful in a variety of circumstances. For example, it can be useful for a product manufacturer or product retailer to retrieve product information in order to help drive future business practices, such as sales promotions or new product development. Unfortunately, there can be a number of obstacles with product information retrieval.

One common way to retrieve product information is during a service telephone call. During the service call, typically in the process of attempting to identify the issue with the product, a trained telephone technician conducts a telephone interview with the product user. The telephone technician typically will explain to the user how to put the product in diagnostic mode, so that the product can display product information. Then the technician asks the user questions about the displayed product information.

Another common way to retrieve product information is during an in-person service call. When a user experiences a product malfunction, a technician may be sent to the physical location of the product to repair the product. As shown in FIG. 1, this allows the technician to directly interface the product through a data port, such as a plug in data port, or an IR data port.

These methods of product information retrieval suffer from a number of flaws. The information is generally skewed because it is collected from products being serviced. Using these methods, it is rare that product information will be collected from normally operating products. Accordingly, the information collected may lead to less than optimal future business practices. Additionally, it can be cost prohibitive to pay a staff of technicians to either interview users or travel and directly interface with products.

Some products include hardware capable of communicating product information over a network to the manufacturer or another third party. However, there can be a number of issues with this approach. It can be cost prohibitive to include communication hardware in every product. And, even if communication hardware is included, the product may not have access to a network for communicating the information.

### SUMMARY OF THE INVENTION

The present invention provides a system and method for product information retrieval with a mailable item. The system may include a product with communication circuitry and memory, a mailable item with communication circuitry and memory, and a collection device with communication circuitry and memory. The method for retrieving product information from a product may include providing a mailable item with a communication system and memory, transferring product information from the product to the mailable item, storing the transferred information, and mailing the mailable item to a recipient who can retrieve the product information.

The present invention may include providing one or more incentives. Incentives may help to ensure that the user transfers the product information on to the mailable item and mails the mailable item back. In one embodiment, the mailable item may include a software update for the product as an incentive for the user to obtain the mailable item. The mailable item may be configured such that installation of the software update is performed simultaneously while transferring the product information on to the mailable item. In another embodiment, in exchange for the user mailing the mailable item to the manufacturer, the manufacturer may offer an incentive such as coupons, promotional materials, discounts, monetary rewards, or a report on the status of the product.

In general, information retrieved using the present invention is collectively more reliable than data retrieved during service calls or service visits because the product from which information is being collected is unrelated to whether or not the product is malfunctioning. Further, the mailable item is generally less expensive than the cost of including hardware capable of communicating product information over a network in the product.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components.

Nor should the use of enumeration be construed as excluding from the scope of the invention any additional steps or components that might be combined with or into the enumerated steps or components.

### BRIEF DESCRIPTION OF THE DRAWINGS

FIG. 1 shows a prior art method of a trained technician retrieving data from a data port on a consumer electronic device during a service call.

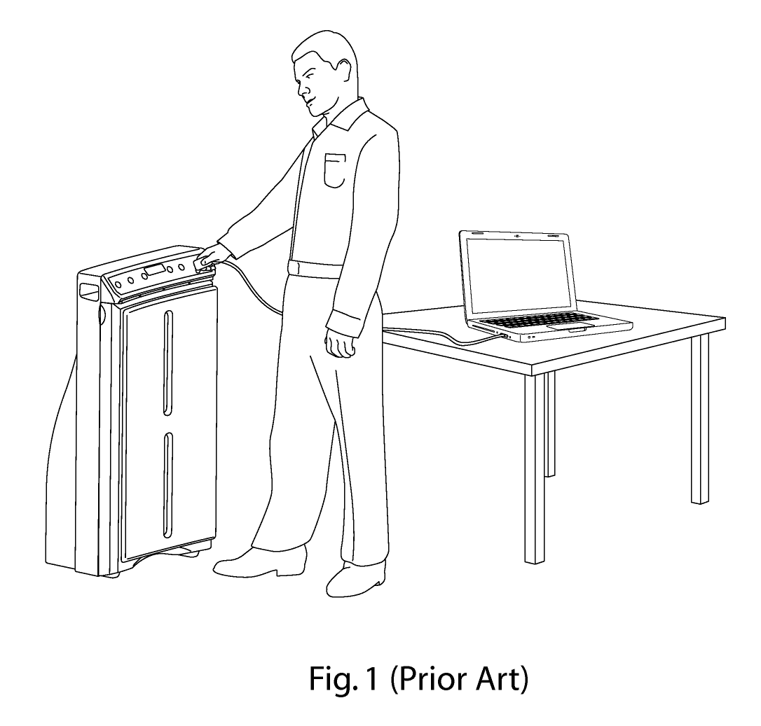

FIG. 2A shows a user transferring product information from a water treatment system using a postcard and mailing it to the manufacturer.

FIG. 2B shows a user transferring product information from a consumer electronic device using a postcard and mailing it to the manufacturer.

FIG. 3 shows a technician retrieving information from a returned postcard.

FIG. 4 shows a circuit block diagram of the system in the consumer electronic device that sends data to the service postcard.

FIG. 5 shows a circuit block diagram a service postcard.

FIG. 6 shows a state diagram of how an exemplary water treatment system recognizes the service postcard and subsequently sends and authenticates the data.

FIG. 7 shows a flowchart of an exemplary postcard used in service/warranty situations.

FIG. 8 shows a flowchart of an exemplary postcard used in mass-mailing situations.

FIG. 9 shows a flowchart of a method of retrieving product information with a postcard.

### DESCRIPTION OF THE CURRENT EMBODIMENTS

A method in accordance with one embodiment of the present invention includes 1) providing a product with memory for storing product information and a wireless communication system for communicating the product information; 2) providing a mailable item having a wireless communication system and memory, 3) transferring product information from the product memory to the mailable item, 4) storing the transferred product information on the mailable item, 5) mailing the mailable item, 6) receiving the mailable item in the mail, 7) retrieving the product information from the memory of the mailable item, 8) storing the product information in a database, and 9) analyzing the product information in the database to drive business practices.

The product can be essentially any type of product that includes memory for storing product information and a wireless communication system for communicating the product information. For example, the product can be a water treatment system, air treatment system, automobile, mobile phone, tablet, or television. Further, although referred to as a product throughout this application, this term is not meant to be limiting and should be construed to include essentially any device or apparatus.

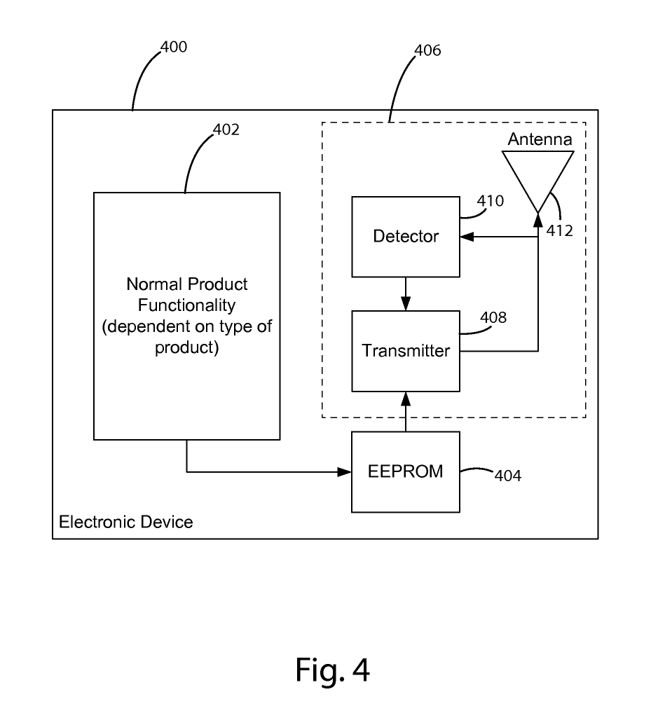

One embodiment of a product is illustrated in FIG. 4 and generally designated 400. The product 400 includes product functionality unit 402, memory 404, and a communication system 406. The content of the product functionality unit 402 varies depending on the type of product. For example, in a water treatment system, the product functionality unit 402 may include one or more of a water filter, a UV lamp, and essentially any other water treatment system components. The product functionality unit 402 is in electrical communication with the memory 404 and can store a variety of product information in the memory 404. The memory 404 in the illustrated embodiment is electrically erasable programmable read-only memory (EEPROM), in alternative embodiments the memory 404 may be a different type of memory.

The communication system 406 in the current embodiment includes a transmitter 408, a detector 410, and an antenna 412. In the current embodiment, the communication system 406 is capable of wireless two-way communication with the mailable item when it is in close proximity. In alternative embodiments, the communication system may be wired or may be capable of only one-way transmission. The communication system can be essentially any type of communication system and can use any of a variety of protocols. For example, the communication system could utilize WiFi, Bluetooth, TransferJet, or RFID technology.

The product information being stored on the product memory can include a variety of different types of product information. The product information can include both dynamic and static information. For example, the static product information may include the product serial number and manufacture date. The dynamic product information or product usage information may include information related to the software version, number of actuations of the product or the times at which the product is used, to name a few examples.

Product usage information may be related to the underlying function of the product. For example, if the product is a water treatment system, the product information may include the total number of power ups, total number of cartridges installed in the water treatment system over its lifetime, total number of water flows for the system, total number of days the system has been in use, total number of hours the current filter has been installed, total amount of volume of water treated through the current filter, total number of water flows through the current filter, total number of water flows with a low battery, total number of flows after the filter end of life, the maximum number of flows of water in a 24 hour period, and the maximum flow in a 24 hour period in the current filter.

Although FIG. 4 illustrates a product having memory and a communication system separate from the product functionality unit, those components may be included in the product functionality unit. During normal operation, some products collect and store product information in memory. Therefore, it may not be necessary to install any additional sensors to collect product information. In other embodiments, one or more sensors can be included with the product in order to track product usage information. Further, some products include a communication system for normal operation. For example, some water treatment systems include an RFID reader/writer for communicating with the replaceable water filter and storing product information related to the water treatment system. When a water filter is replaced, the water treatment system RFID reader/writer can recognize that a new filter has been installed and can update the product information accordingly. Accordingly, in some embodiments, product information may be transferred to a mailable item using a product's pre-existing communication system and memory.

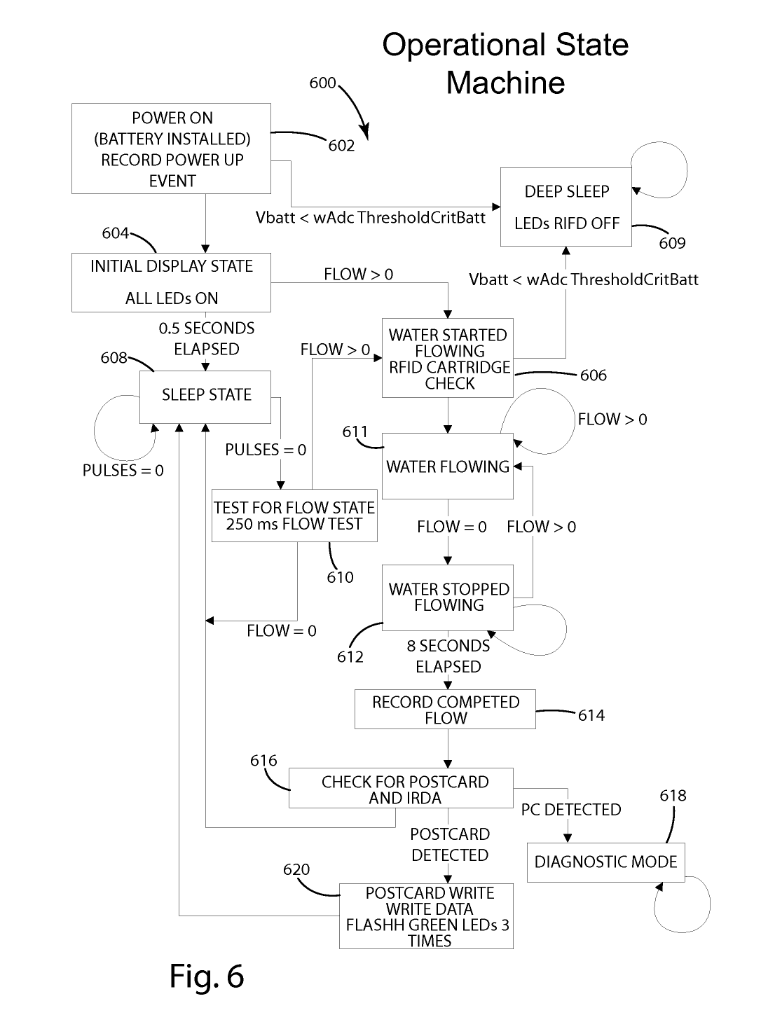

An exemplary operational state machine for a water treatment system in accordance with an embodiment of the present invention is illustrated in FIG. 6, and generally designated 600. The state diagram illustrates how product information in one embodiment is recorded. When the power is turned on and the battery is installed, a power up event is recorded in the water treatment system memory 602. After powering up, the water treatment system goes into the initial display state where all the LEDs are turned on 604. If water is flowing, the water treatment system checks the filter cartridge RFID tag 606. If water is not flowing, after a short delay, the water treatment system enters a sleep state 608. After a predetermined time, the system pulses and enters a state where it tests whether water is flowing in the water treatment system 610. In the current embodiment this test takes about 250 ms. If water is not flowing, the water treatment system reverts back to the sleep state 608. If water is flowing, the water treatment system checks the filter cartridge RFID tag 606. If the battery is below a critical battery threshold, the system enters a deep sleep state where the LEDs and RFID reader are turned off 609. Once the battery goes above the threshold, the system moves to the power up state 602. If the battery level is acceptable, the system enters a water flowing state 611. When the flow stops, the system moves to a water stopped flowing state 612 for 8 seconds. If water begins flowing within those 8 seconds, the system moves back to the water flowing state 610. If water does not begin flowing during those 8 seconds, then the system records a completed flow 614 and checks whether a PC or an RFID postcard are present 616. If a PC is detected, the system enters diagnostic mode 618. If an RFID postcard is detected, the system writes data to the postcard and flashes the green LEDs 3 times to indicate that the data has been transferred to the postcard 620. If no postcard or PC was present, or once the data is written to the postcard, the system enters the sleep state 608.

In some embodiments, the RFID reader/writer of the product may interact with multiple RFID tags. For example, in the operational state diagram described in FIG. 6, the water treatment system checks for an water filter RFID tag and also checks for an RFID tag in a postcard. The system can distinguish between these two RFID tags by utilizing a password. For example, the RFID postcard by default may be provided with 8 blocks of data. In one embodiment, Block 0 is read only during use and includes tag configuration data, block 1 includes the unit serial number, block 2 includes the software version code, the total number of power ups, and the total number of cartridges used, block 3 includes the total number of water flows in the system and the total days the system has been in use, block 4 includes the amount of time the filter has been installed in hours and the amount of water the filter has treated in gallons, block 5 includes the total number of flows of the current filter, the number of flows with the current filter while the battery is low, and the number of flows after the end of life of the current filter, block 6 includes the maximum number of flows that have occurred over a 24 hour period of the current filter, the maximum number of flows that have occurred over a 24 hour period in gallons, any system messages regarding read/write errors, and a checksum, block 7 includes the postcard tag password, which has a predefined value. The RFID tag for the water filter has a different password so that the system can distinguish between the RFID tag for the water filter and the RFID for the postcard.

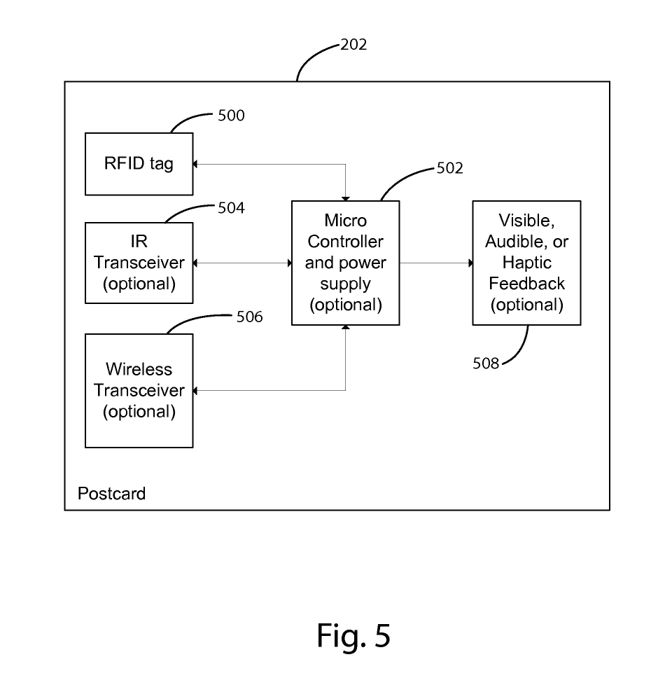

A mailable item in accordance with one embodiment of the present invention includes memory and a communication system. The memory and communication system can be separate components that are integral with the mailable item or fastened to the mailable item. For example, in one embodiment, the memory and communication system are included in an RFID tag that is attached to the mailable item with adhesive. A block diagram of one embodiment of a mailable item is illustrated in FIG. 5. In FIG. 5, the mailable item is a postcard 202 that includes an RFID tag 500. In the current embodiment, the RFID tag is both memory and a communication system. Optionally, the postcard 202 of the current embodiment may include additional components such as a microcontroller and power supply 502, an IR transceiver 504, a wireless transceiver 506, and a feedback module 508.

A mailable item refers to any item that can be mailed using any service for delivering an item. Reference to mailing a mailable item refers to placement of a mailable item in a post office, mailbox or other courier service for transmission. For example a mailable item may include any item that is capable of being mailed utilizing a national postal service or a courier service such as UPS or FedEx. One mailable item in accordance with an embodiment of the present invention is a postcard. A postcard is generally defined as an object that can be mailed by itself without the use of an envelope or other packaging. In one embodiment, a postcard may includes a rectangular piece of thick paper or thin cardboard intended for writing and mailing without an envelope. In some places, it may be possible to send a postcard for a lower fee than a letter. Another mailable item in accordance with an embodiment of the present invention is a pre-stamped envelope. The pre-stamped envelope may include memory and a communication sticker.

The mailable item can be a unitary item or a multi-part item. In embodiments where the mailable item is a unitary item, the mailable item may include predefined destination information, a wireless communication system, and memory all joined to form a single item that can be delivered to a recipient. In embodiments where the mailable item is a multi-part item, the mailable item can include a package with predefined destination information and a product usage information module that includes a wireless communication system and memory. In this embodiment, the package and the product usage information module are separable parts such that the product information module can be removed from the package for use and inserted into the package for mailing. For example, an RFID tag and a self addressed stamped envelope together can form a multi-part mailable item. The package can be essentially any type of package that can be mailed, such as a mailer, envelope, or box.

In the current embodiment, the RFID tag 500 is both a wireless communication system and memory. Therefore, the RFID tag can both receive and store product information communicated from a product. In alternative embodiments, the RFID tag may be replaced by a different communication system and memory. For example, an infrared (IR) transceiver 504 and memory or a wireless transceiver 506 and memory could replace the RFID tag on the postcard.

The postcard may include a microcontroller and power supply. The microcontroller and power supply can have a variety of uses on the postcard. In one embodiment, the microcontroller in conjunction with the communication system can be programmed to upload a software update to the product.

The postcard or the product may also include a feedback module. In the current embodiment, the feedback module can provide feedback regarding the status of the product information transfer through visual, audible, or haptic feedback. In alternative embodiments, the feedback module can provide feedback regarding additional items. For example, in some embodiments, the feedback module can provide status of the software update through visual, audible, or haptic feedback.

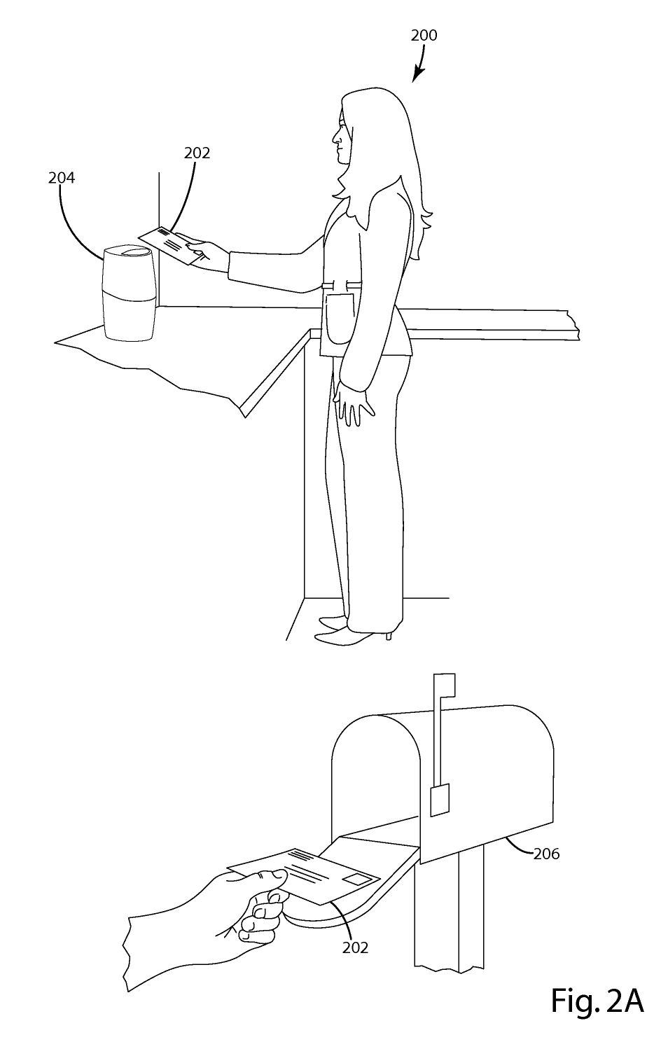

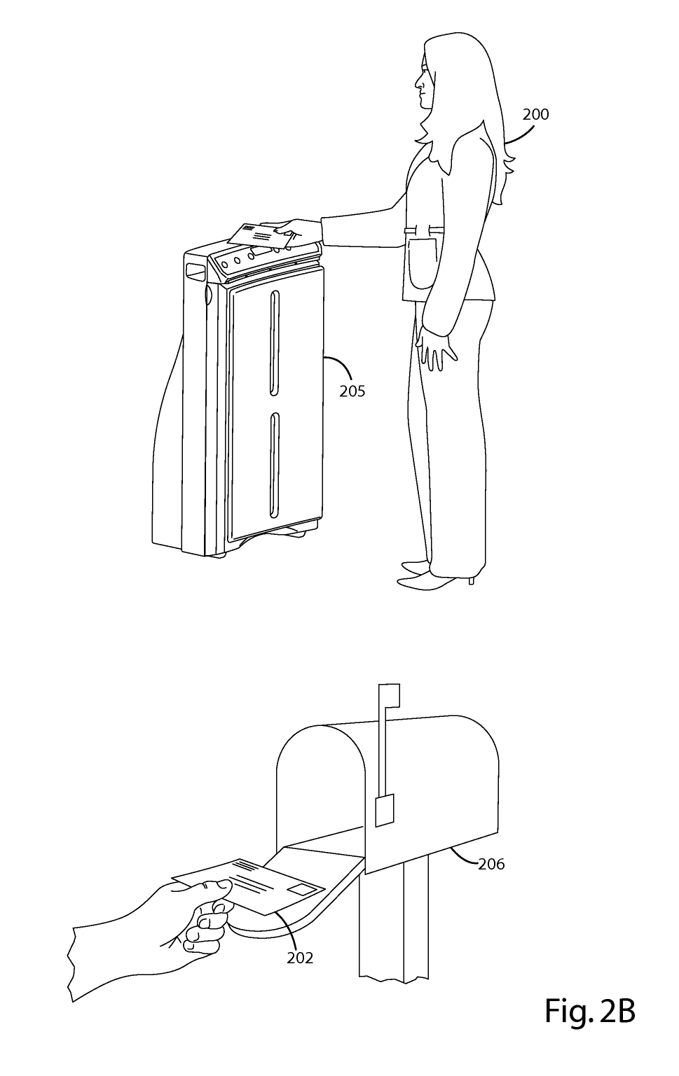

Some embodiments of the method can be performed by a product user or a product manufacturer. For example, a method in accordance with one embodiment of the present invention is performed entirely by a product user, the method includes 1) providing a postcard with a communication system and memory, 2) transferring product information from a water treatment system onto the postcard, 3) storing the transferred information in postcard memory, and 4) mailing the postcard. An example of this embodiment of the method is illustrated in FIG. 2A. The product user 200 is holding a postcard 202 that includes a communication system and a memory. The postcard 202 is being held in proximity to the water treatment system 204 so that the water treatment system 204 can wirelessly communicate with the postcard 202. The communication permits the postcard 202 to transfer product information from the water treatment system onto the postcard. The postcard stores the transferred information in memory. Finally, the postcard 202 is shown being inserted into a mailbox 206 to be mailed.

Another method in accordance with one embodiment of the present invention is performed entirely by a product user, the method includes 1) providing a postcard with a communication system and memory, 2) transferring product information from a consumer electronic product onto the postcard, 3) storing the transferred information in postcard memory, and 4) mailing the postcard. An example of this embodiment of the method is illustrated in FIG. 2B. The product user 200 is holding a postcard 202 that includes a communication system and a memory. The postcard 202 is being held in proximity to the consumer electronic device 205 so that the consumer electronic device 205 can wirelessly communicate with the postcard 202. The communication permits the postcard 202 to transfer product information from the consumer electronic device 205 onto the postcard 202. The postcard 202 stores the transferred information in memory. Finally, the postcard 202 is shown being inserted into a mailbox 206 to be mailed.

The methods described in connection with FIGS. 2A-2B are exemplary. One difference between the two described methods is that one method transfers product information from a consumer electronic product and one method transfers product information specifically from a water treatment system. Of course, it should be understood that consumer electronic products can include a wide variety of items including water treatment systems, air treatment systems, automobiles, mobile phones, tablets, televisions, to name a few. In one embodiment, an a steering wheel or other vehicle component can be RF enabled and can be use to upload product information about the vehicle such as fault codes and usage information to a mailable item.

In some embodiments, the method for retrieving product information is performed by a manufacturer or other entity interested in analyzing a collection of product information. In some embodiments, the mailable items are mailed to a service center where the product information can be retrieved from the mailable items by a third party.

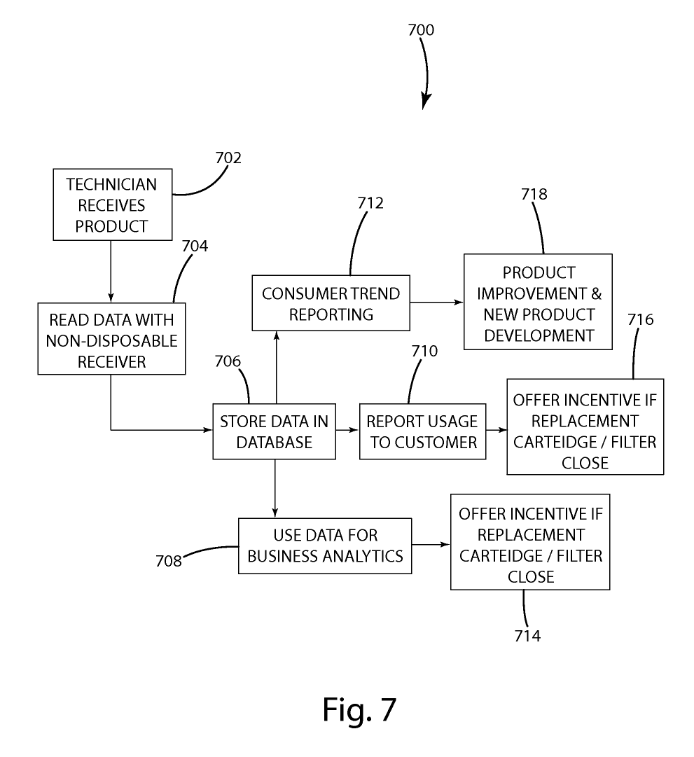

FIG. 7 illustrates a flowchart of one embodiment of a method for retrieving product information performed by a manufacturer, and is generally designated 700. The technician receives a postcard 702. The product information from the postcard is read with a non-disposable receiver 704 and stored in a database 706. The product information can be used for business analytics 708, for generating a report on product usage to the customer 710, and to report on consumer trends 712. An incentive may be offered if it is near the time when a replacement cartridge/filter is needed 714, 716. And, by analyzing the consumer trends product improvements can be made and new products can be developed 718.

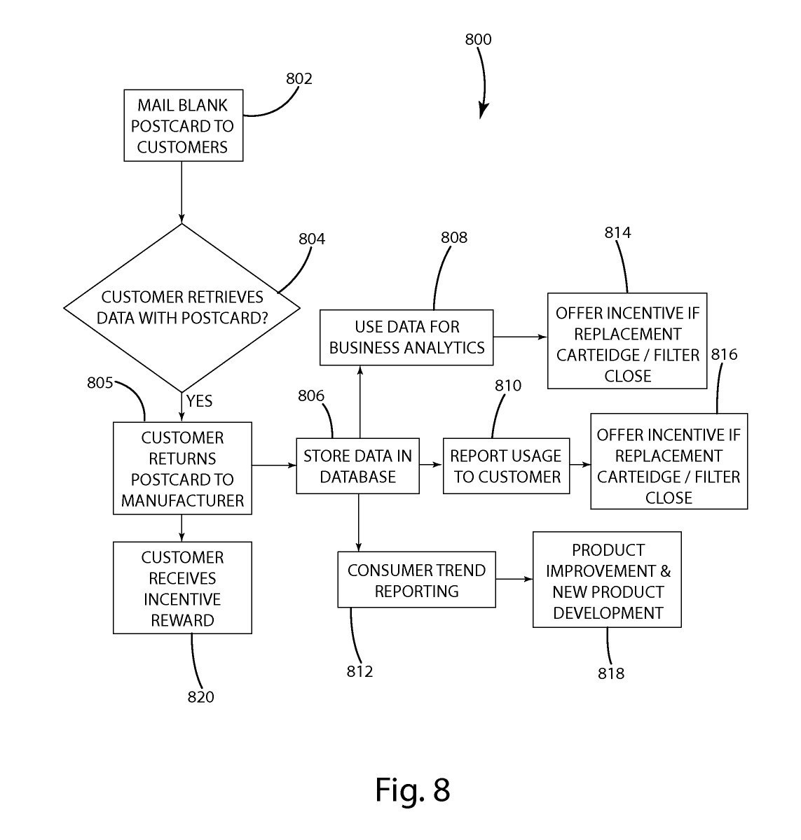

FIG. 8 illustrates a flowchart of another embodiment of a method for retrieving product information performed by a manufacturer, and is generally designated 800. In this embodiment, the product manufacturer mails blank postcards to customers 802. Customers transfer and store product information on the postcard 804 and mail the postcard back to the manufacturer 805. The customer may receive an incentive reward for returning the postcard 820. The product information is read and stored in a database 806. The product information can be used for business analytics 808, for generating a report on product usage to the customer 810, and to report on consumer trends 812. An incentive may be offered if it is near the time when a replacement cartridge/filter is needed 814, 816. And, by analyzing the consumer trends product improvements can be made and new products can be developed 818.

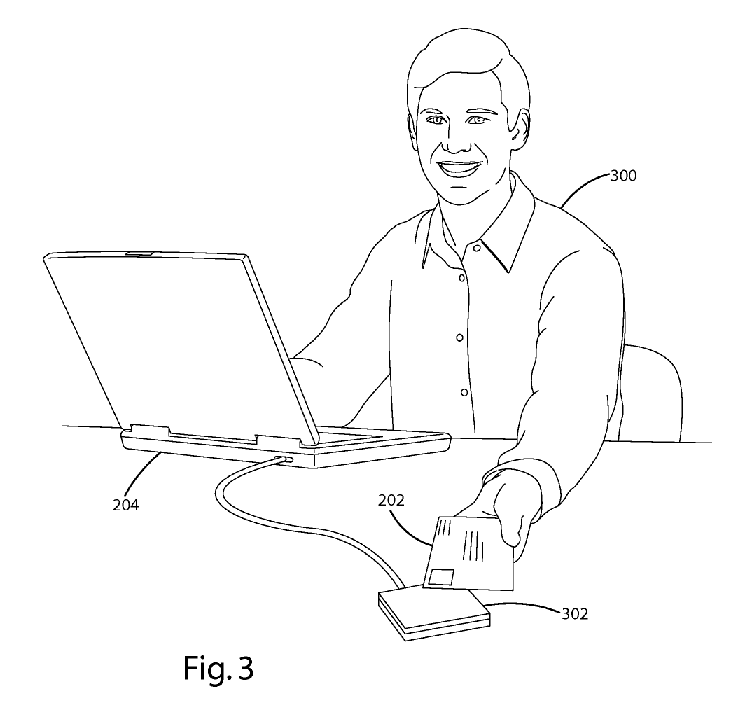

In FIG. 3, a technician 300 is shown utilizing an RFID reader 302 to retrieve product information from a returned postcard 202. When the postcard 202 is brought in proximity of the RFID reader 302, the product information from the postcard 202 can be retrieved. The RFID reader 302 is connected to a laptop computer 304 with a universal serial bus (USB) cable. In the current embodiment, the product information can be stored in a database on the laptop, or the laptop can store the product information in a remote database by communicating over a network.

The present invention may include providing one or more incentives. Incentives may help to ensure that the user transfers the product information on to the postcard and mails the postcard back. In one embodiment, the postcard may include a software update for the product as an incentive for the user to obtain the postcard. The postcard may be configured such that installation of the software update is performed simultaneously while transferring the product information on to the postcard. In another embodiment, in exchange for the user mailing the postcard, the manufacturer may offer an incentive such as coupons, promotional materials, discounts, monetary rewards, admittance to an event sponsored by the product manufacturer, or a report on the status of the product.

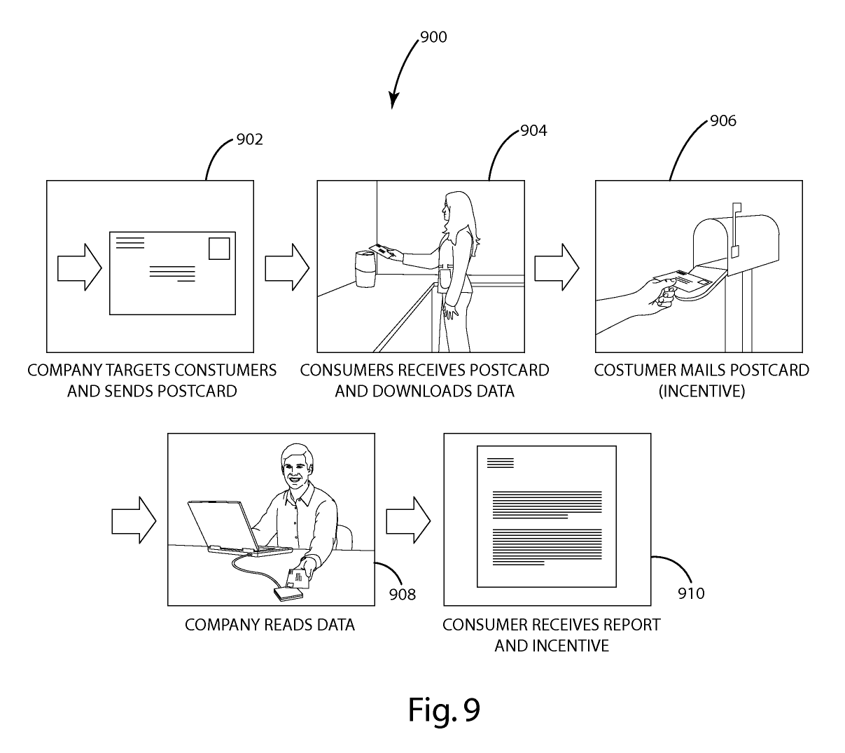

An example of a method for retrieving product information is illustrated in FIG. 9. A product manufacturer targets customers and sends or hand delivers postcards to them 902. The postcard may include one or more incentives the customer to transfer the data and mail the postcard back, such as such as coupons, promotional materials, discounts, monetary rewards, or a report on the status of the product. Once the customer receives the postcard, they transfer the product information stored on their product to the postcard 904 and mail the postcard back to the manufacturer 906. The manufacturer receives the postcard in the mail and a technician reads the data off the postcard and stores it in a database 908. The manufacturer then prepares a report and sends the report to the customer along with the promised incentive for transferring the product information on to the postcard and returning the postcard 910.

In one embodiment, the method of product information retrieval can be implemented even in products that have memory and communication systems that are not currently programmed to communicate with a mailable item. The mailable item may include a software update that includes the programming for the product to communicate with the mailable item for purposes of transmitting product information to the mailable item. In this way, even products already existing in the field can be easily updated to have the capability to provide information to a mailable item, such as a postcard that a customer receives in the mail. The updates to the product can be firmware upgrades that provide new features, turn on/off features, or fix bugs.

In one embodiment, the manufacturer can send postcards to a block of customers and incentivize them to send the postcards back. This grants the ability to analyze the information and provide feedback to customers. User habit information can be culled from the product information and help to provide specific reports to the customer. Further, the information can be used collectively to make assessments about the product information as a whole.

The system and method for product information retrieval with a mailable item can provide a variety of different functions. In one embodiment, the product information on the mailable item includes usage information that allows important information to be reported back to the user or utilized by the manufacturer for business development. For example, some of the usage information that can be collected includes system usage data, filter usage, remaining life, serial number, system configuration, and usage statistics such as averages, medians: flow rate, use time, pressure, and temperature. In another embodiment, the mailable item functions as a mailable “black box” that can report diagnostics and fault conditions. For example, the mailable item can collect data of the last 30 days of detailed use data, diagnostic data, and calibration data. In another embodiment, the mailable item can be an interactive RFID postcard for testing and reporting. For example, the RFID postcard and/or the product can display results with OLEDs, LEDs, or eInk. The product can provide wireless energy to power the electronics on the postcard. The interactive system can allow user queries and responses to be stored. The postcard may include one or more batteries to run a processor on the postcard. In another embodiment, the mailable item can be an RFID postcard with a survey. The text on the RFID postcard may include a survey for the user to fill out so that the postcard accomplishes two functions, transferring product information on to the postcard and providing a survey to the user. In another alternative embodiment, the mailable item can be a push postcard that queries the product and can upload data to the system. For example, the uploaded data can be utilized to reset faults, set configuration parameters, and upload software revisions. Thin battery technology may be utilized to integrate a battery in or on the postcard in order to increase the amount of data that can be transferred. A variety of different features of various embodiments of the mailable item have been described. It should be understood that some embodiments may include mailable items with a combination of these features and their corresponding components.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method for retrieving product information from a product comprising the steps of:
providing a mailable item having a wireless communication system and memory;
providing the product having a wireless communication system and memory, wherein the product is configured to transfer product usage information about the product to the mailable item;
receiving the mailable item, wherein the memory in the mailable item includes the product usage information from the product;
retrieving the product usage information from the memory of the mailable item with a wireless collection device.

2. The method of claim 1 wherein the mailable item includes a software update for the product as an incentive to obtain the mailable item.

3. The system of claim 2 wherein the mailable item is configured such that installation of the software update is performed simultaneously while the product usage information is received from the product.

4. The method of claim 1 includes offering an incentive to return the mailable item.

5. The method of claim 4 wherein the incentive includes at least one of a coupon, promotional material, a discount, a monetary reward, admittance to an event, and a report on the status of the product.

6. The method of claim 1 wherein the product is a water treatment system and the product usage information includes at least one of number of power ups, number of cartridges installed in a water treatment system, number of water flows for the product, number of days the system has been in use, total number of hours the current filter has been installed, total amount of volume of water treated through the current filter, total number of water flows through the current filter, total number of water flows with a low battery, total number of flows after the filter end of life, the maximum number of flows of water in a 24 hour period, and the maximum flow in a 24 hour period in the current filter.

7. The method of claim 1 including:
storing the product usage information in a database; and
analyzing the product usage information in the database.

8. The method of claim 1 wherein the mailable item is a unitary item including destination information, the wireless communication system, and the memory.

9. The method of claim 1 wherein the mailable item is a multi-part item including two or more separable parts, the multi-part item includes a package with predefined destination information and a product usage information module including the wireless communication system and memory.

10. A method for retrieving product information from a product comprising the steps of:
obtaining a product having a wireless communication system and memory;
obtaining a mailable item having a wireless communication system and memory;
transferring product usage information from the memory of the product onto the mailable item wirelessly using the wireless communication system of the product and the wireless communication system of the mailable item;
storing the product usage information in memory on the mailable item.

11. The method of claim 10 wherein the mailable item is a unitary item including destination information, the wireless communication system, and the memory.

12. The method of claim 10 wherein the mailable item is a multi-part item including two or more separable parts, the multi-part item includes a package with predefined destination information and a product usage information module including the wireless communication system and memory.

13. The method of claim 10 including mailing the mailable item to a recipient for retrieval of the product usage information.

14. The method of claim 10 wherein the product wireless communication system comprises an RFID reader/writer and the mailable item wireless communication system comprises a postcard with an RFID tag.

15. The method of claim 10 wherein the mailable item includes a software update for the product as an incentive to obtain the mailable item.

16. The system of claim 15 wherein the mailable item is configured such that installation of the software update is performed simultaneously while the product usage information is transferred on to the mailable item.

17. The method of claim 10 includes offering an incentive to mail the mailable item to the recipient.

18. The method of claim 17 wherein the incentive includes at least one of a coupon, promotional material, a discount, a monetary reward, admittance to an event, and a report on the status of the product.

19. The method of claim 10 wherein the product is a water treatment system and the product usage information includes at least one of number of power ups, number of cartridges installed in a water treatment system, number of water flows for the product, number of days the system has been in use, total number of hours the current filter has been installed, total amount of volume of water treated through the current filter, total number of water flows through the current filter, total number of water flows with a low battery, total number of flows after the filter end of life, the maximum number of flows of water in a 24 hour period, and the maximum flow in a 24 hour period in the current filter.

20. A system for retrieving product information from a product comprising:
a mailable item with a wireless communication system and memory;
a product having a wireless communication system, memory, a controller, and one or more sensors for measuring product usage information, wherein the controller is programmed to wirelessly transfer the product usage information to the mailable item using the wireless communication system of the product and the wireless communication system of the mailable item; and
a collection device for collecting the product usage information from the memory of the mailable item.

21. The method of claim 20 wherein the mailable item is a unitary item including destination information, the wireless communication system, and the memory.

22. The method of claim 20 wherein the mailable item is a multi-part item including two or more separable parts, the multi-part item includes a package with predefined destination information and a product usage information module including the wireless communication system and memory.

23. The system of claim 20 wherein the product wireless communication system comprises an RFID reader/writer and the mailable item wireless communication system comprises a postcard with an RFID tag.

24. The system of claim 20 wherein the mailable item includes a software update for the product as an incentive to obtain the mailable item.

25. The system of claim 24 wherein the mailable item is configured such that installation of the software update is performed simultaneously while the product usage information is transferred on to the mailable item.

26. The method of claim 20 includes offering an incentive to mail the mailable item to the recipient.

27. The method of claim 26 wherein the incentive includes at least one of a coupon, promotional material, a discount, a monetary reward, admittance to an event, and a report on the status of the product.

28. The method of claim 20 wherein the product is a water treatment system and the product usage information includes at least one of number of power ups, number of cartridges installed in a water treatment system, number of water flows for the product, number of days the system has been in use, total number of hours the current filter has been installed, total amount of volume of water treated through the current filter, total number of water flows through the current filter, total number of water flows with a low battery, total number of flows after the filter end of life, the maximum number of flows of water in a 24 hour period, and the maximum flow in a 24 hour period in the current filter.
